(19) United States
(12) Patent Application Publication
(10) Pub. No.: US 2026/0072959 A1
(43) Pub. Date: Mar. 12, 2026

(54) MULTI-TASK RETRIEVER MODELS FOR IN-CONTEXT EXAMPLE SELECTION

(71) Applicant: Google LLC, Mountain View, CA (US)

(72) Inventors: Kazuma Hashimoto, Menlo Park, CA (US); Arjun Reddy Akula, Sunnyvale, CA (US); Karthik Raman, San Jose, CA (US); Michael Bendersky, Cupertino, CA (US)

(21) Appl. No.: 19/325,226

(22) Filed: Sep. 10, 2025

Related U.S. Application Data
(60) Provisional application No. 63/693,115, filed on Sep. 10, 2024.

(51) Int. Cl. G06F 16/3332; G06F 16/3329

(52) U.S. Cl. CPC G06F 16/3337; G06F 16/3329

(57) ABSTRACT

Methods, systems, and apparatuses, including computer programs encoded on computer storage media, for performing a task on a query using a generative neural network by making use of demonstration examples, where the demonstration examples are selected using a retrieval model (i.e., a retrieval system that includes a demonstration encoder neural network and a query encoder neural network). By not processing any data identifying the respective example output of a demonstration example when generating the corresponding demonstration embedding for the demonstration example, the generalization of a retrieval model is improved. Further, by augmenting the training data set for the retrieval model using translation of tasks, the generalization of the retrieval model is further improved. As a result, a single, generalized retrieval model can be effectively used for a plurality of tasks, eliminating the need to train, store, and deploy multiple, specialized retrieval models.

### CROSS-REFERENCE TO RELATED APPLICATIONS

This application claims priority of U.S. Provisional Application No. 63/693,115 filed Sep. 10, 2024. The contents of the prior application is incorporated herein by reference in its entirety.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that performs a task on a query using a generative neural network, e.g., a language model neural network, e.g., a large language model neural network (LLM), by making use of demonstration examples, i.e., through in-context learning.

Particular embodiments of the subject matter described in this specification can be implemented so as to realize one or more of the following advantages.

In-context learning refers to a method for performing a task by making use of demonstration examples. For example, a generative neural network can make use of demonstration examples provided in its input prompt to perform a task. This technique allows a pre-trained neural network to perform a task with greater performance without requiring fine-tuning of its parameters.

The performance of a generative neural network using in-context learning is highly dependent on the quality of the demonstration examples provided to it. Retrieval models can be used to select and provide demonstration examples to the generative neural network, e.g., to give the generative neural network additional context to generate an output in response to receiving a query. But while retrieval models can select these demonstration examples, they suffer from poor generalization. That is, these retrieval models often fail to retrieve useful demonstrations for new, “unseen” tasks, relative to the tasks included in the training of the retrieval models. As a result, some techniques attempt to overcome this limitation by training, storing, and deploying a separate, specialized retrieval model for each individual task or group of related tasks. These approaches are computationally expensive and inefficient because they 1) require significant computational resources and time to train each retrieval model, 2) require substantial memory to store the parameters for the plurality of different retrieval models, and 3) increase the complexity of managing and serving these multiple retrieval models during inference (e.g., generating and output in response to a user query).

This specification describes techniques that can address the aforementioned challenges. That is, by avoiding the use of a demonstration's output when generating demonstration embeddings, the described techniques improve the generalization of a retrieval model (i.e., a retrieval system that includes a demonstration encoder neural network and a query encoder neural network) by preventing the retrieval model from overfitting to the specific output formats of the tasks used during training. This enables the retrieval model to effectively select demonstration examples for new, unseen tasks even when their output formats are substantially different from the training tasks. Additionally, the described techniques' augmentation of a training dataset using translations of tasks, further improve the generalization of a retrieval model. This process exposes the retrieval model to a plurality of different languages during training, which encourages it to learn language-agnostic representations and improves its performance in multi-lingual and cross-lingual scenarios. With improved generalization of the retrieval model across tasks (seen during training, unseen during training, and for a variety of languages) the described techniques improve the functionality of a computer system by enabling the use of a single retrieval model to generate outputs in response to queries, whereas other techniques require a plurality of retrieval models for a respective plurality of tasks to yield equivalent performance for the generative neural network processing the selected demonstration examples.

By generating a demonstration embedding for a demonstration example by processing only a task instruction for the particular task and the respective example query from the demonstration example, while specifically excluding any data identifying the respective example output (e.g., the literal example output or a description of the example output), the described techniques create a more generalized demonstration embedding. This prevents the retrieval model from overfitting to tasks during training and failing to retrieve appropriate demonstration examples when encountering new tasks. As a result of the retrieval model being more versatile and being able to operate across a wider range of tasks, the described techniques confer a direct improvement to a computer system's functionality by avoiding computationally expensive retraining of the retrieval model for every task (as is needed by some techniques to achieve similar performance for a generative neural network).

By generating one or more new, synthetic, multi-lingual tasks to include in the training data set, the described techniques further improve the generalization of a retrieval model. That is, by translating a set of candidate demonstrations from a task into one natural language and translating the set of query demonstrations from the task into another natural language the described techniques can augment the training data set. Then, the described techniques can train the retrieval model with the augmented training data set to ensure that the retrieval model is not language-specific but instead language-agnostic. As a result, the retrieval model performs well for a wider range of tasks (e.g., cross-lingual sentiment classification and cross-lingual intent classification). Again, as a result of the retrieval model being more versatile and being able to operate across a wider range of tasks, the described techniques confer a direct improvement to a computer system's functionality by avoiding computationally expensive retraining of the retrieval model for every task (as is needed by some techniques to achieve similar performance for a generative neural network).

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows a retrieval system.

FIG. 2 is a flow diagram of an example process for generating an output for a particular task and query.

FIG. 3 is a flow diagram of an example process for training a demonstration encoder neural network and a query encoder neural network using a contrastive learning objective.

FIG. 4 is an example of the performance of the described techniques.

FIG. 5 is an example of the performance of the described techniques.

FIG. 6 is an example of the performance of the described techniques.

FIG. 7 is an example of the performance of the described techniques.

Like reference numbers and designations in the various drawings indicate like elements.

### DETAILED DESCRIPTION

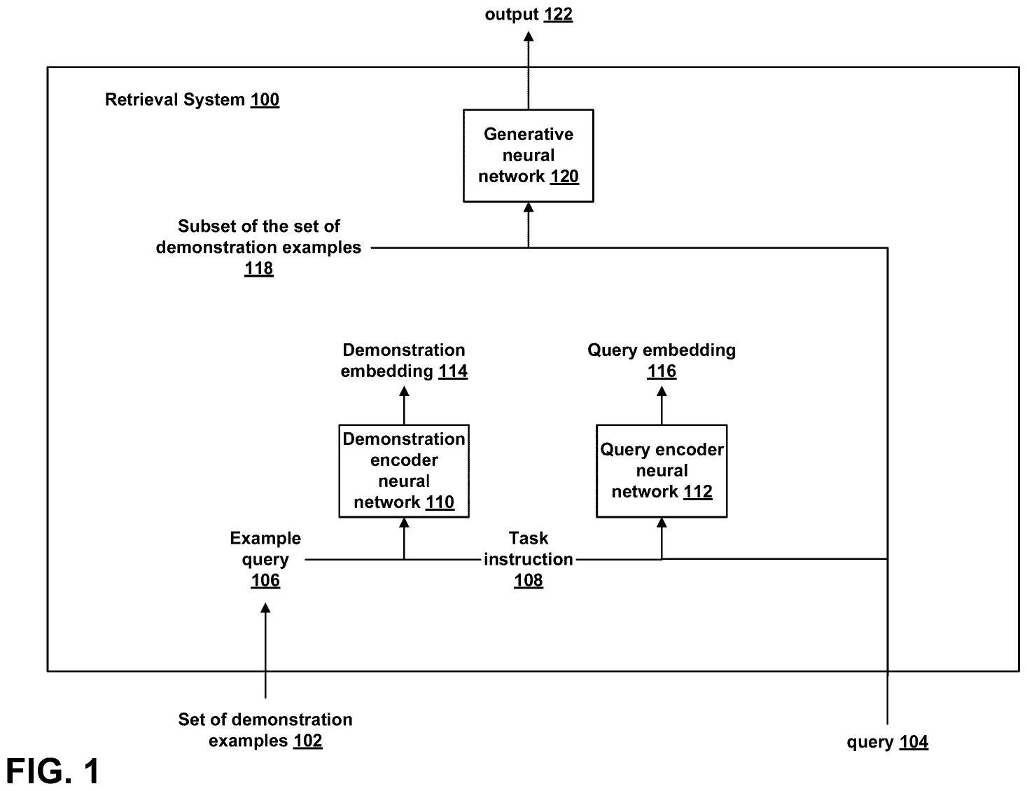

FIG. 1 shows a retrieval system 100. The system 100 is an example of a system implemented as computer programs on one or more computers in one or more locations, in which the systems, components, and techniques described below can be implemented.

The system 100 can perform a task on a query 104 using a generative neural network 120, e.g., a language model neural network, e.g., a large language model neural network (LLM), by making use of a set of demonstration examples 102.

More specifically, the system 100 obtains a set of demonstration examples 102 for a particular task.

The particular task can be any of a variety of types of tasks. For example, the task can be a translation, a paraphrasing task, a natural language inference task, a reasoning task, a classification task, an extraction task, a tagging task, a generation task, a summarization task, and so on. Further examples of tasks are provided below.

Generally, each demonstration example 102 includes a respective example query 106 and a respective example output for the respective example query 106. So, for example, if the task were a machine translation task (e.g., an English to Spanish language translation) then each demonstration example 102 could include an English sentence as the respective example query and a Spanish translation of the English sentence as the respective example output for the respective example query.

While the example above describes a machine translation task, the system 100 can obtain and process different sets of demonstration examples for a plurality of different tasks. For example, the system 100 may have access to one set of demonstration examples for a sentiment classification task and a different set for a code summarization task.

For each demonstration example 102, the system 100 processes a task instruction 108 for the particular task and the respective example query 106 in the demonstration example 102 using a demonstration encoder neural network 110 to generate a respective demonstration embedding 114 for the demonstration example 102.

As an example task instruction 108, a task instruction 108 for the particular task of machine translation of English to Spanish can be “Translation: English to Spanish” or “The goal of this task is to translate from English to Spanish.”

An embedding is an ordered collection of numerical values, e.g., a vector of floating point or other numerical values. For example, an n-dimensional vector of numbers, where n can be any positive integer. So, the demonstration embedding 114 is an ordered collection of numerical values.

Generally, the system 100 can store the generated demonstration embeddings 114 and then use the stored generated demonstration embeddings 114, e.g., in an index or other data structure, so that the stored set of demonstration embeddings 114 can be re-used for each query 104 that is received for the particular task.

The system 100 obtains a query 104 for the particular task. As an example, the query 104 for the particular task of translating English to Spanish can be “Where is the library”.

The system 100 processes the task instruction 108 for the particular task and the query 104 for the particular task using a query encoder neural network 112 to generate a query embedding 116 for the demonstration example.

Advantageously, the demonstration encoder neural network 110 and the query encoder neural network 112 are generalized, multi-task encoders. This allows the same encoders to be used to process demonstrations and queries for a plurality of different tasks without requiring task-specific retraining.

Similar to the case of the demonstration embedding 114, the query embedding 116 is also an ordered collection of numerical values.

The demonstration encoder neural network 110 and query encoder neural network 112 each can each have any appropriate architecture in any appropriate configuration that can process the task instruction 108 and a query (e.g., example query 106 or query 104) to generate an embedding (e.g., demonstration embedding 114 or query embedding 116), including fully connected layers, convolutional layers, recurrent layers, attention-based layers, and so on, as is appropriate. In some cases, the demonstration encoder 110 and query encoder 112 are the same neural network.

As a particular example, both encoders can be the same self-attention neural network, e.g., the encoders can be based on the encoder portion of a pre-trained mT5 large model, which is a massively multilingual text-to-text Transformer model.

The system 100 selects, as relevant demonstration examples for the query 104, a subset of the set of demonstration examples 118 using the query embedding 116 and the respective demonstration embeddings 114 for the demonstration examples in the set of demonstration examples 102.

For example, the system 100 can select, as the subset 118, the k (e.g., k=1, 2, 4, 10, or 100) demonstration examples that have demonstration embeddings 114 that are most similar to the query embedding 116 according to a similarity measure, e.g., cosine similarity, cosine distance, or Euclidean distance.

The set of demonstration examples and their corresponding demonstration embeddings can be very large, e.g., thousands or millions of entries stored in an index or other data repository. To efficiently identify the most similar demonstration examples 118 for a given query embedding 116, the system 100 can perform a search through the set of demonstration examples, e.g., a k-nearest neighbor (k-NN) search over the stored demonstration embeddings. As particular examples, the search can be performed using an exact top-k algorithm or, for improved performance on large-scale repositories, an approximate nearest neighbor (ANN) search algorithm to find the k demonstration embeddings that are most similar to the query embedding 116.

After selecting relevant demonstration examples 118 for the query, the system 100 processes a generative input that includes the query 104 and the relevant demonstration examples 118 using a generative neural network 120 to generate an output 122 for the particular task for the query 104.

As an example, for the particular task of translating English to Spanish and for the query 104 that is “Where is the Library?”, the output 122 can be “ [symbol] Donde esta la biblioteca?” The generative input, for example, can be a formatted text string that arranges the relevant demonstration examples 118 before the query 104, such as:
“The goal of this task is to translate from English to Spanish.
Input: Hello world
Output: Hola mundo
Input: How are you?
Output: [symbol] Cómo estás?
Input: Good morning
Output: Buenos días
Input: Where is the Library?
Output:”

The generative neural network 120 can be any appropriate neural network that receives as input a sequence of tokens and processes the sequence of tokens to generate an output sequence of tokens. A ‘token’ is data that represents a unit of data, e.g., a text symbol or data of another modality, e.g., a portion of an image, audio signal, or video signal. For example, a ‘token’ can be a one-hot vector or a dense embedding.

In some cases, the generative neural network 120 is a language model neural network that processes tokens representing text symbols or a multi-modal language model neural network that can process tokens representing text symbols and tokens representing data of one or more other modalities, e.g., image, video, audio, and so on. As a particular example of this, the generative neural network 120 can be an auto-regressive neural network that generates the tokens in the output sequence auto-regressively, i.e., one after another. One example of such a neural network is a decoder-only Transformer neural network. For example, the generative neural network can be one that belongs to the Gemini family of neural networks, the Gemma family of neural networks, and so on.

Advantageously, the system 100 can use the same query encoder 112 and the same demonstration encoder 110 for multiple tasks, i.e., without needing to retrain the query encoder 112 and the demonstration encoder 110 before using them for a new task.

For example, the query encoder neural network 112 and the demonstration encoder neural network 110 can have been trained through contrastive learning on a respective set of training tuples for each of a plurality of different tasks.

As a particular example, the different tasks can include tasks in different natural languages. In some cases, the system 100 can expand the number of tasks through translation. For example, the system 100 can translate a set of queries for a given task into one language and a set of candidate demonstrations for the given task into another language to generate training data for a new, multi-lingual task.

The particular task and the different training tasks can each be any appropriate machine learning task. Some examples of tasks now follow.

For example, the machine learning task can be a text processing task.

A “text processing” task is any task that requires processing an input that includes a sequence of text, i.e., a sequence of text tokens, generating an output that includes a sequence of text tokens, or both.

The text tokens can be tokens selected from a vocabulary of text tokens that includes, e.g., one or more of characters, word pieces, words, punctuation marks, numerical symbols, or any other text symbols.

For example, the text processing task can be a text rewriting task that requires processing an input text sequence to generate an output text sequence that is a rewritten version of the input text sequence.

For example, one text rewriting task can be to generate an output text sequence that is a more formal version of the input text sequence but that conveys the same semantic meaning.

As another example, one text rewriting task can be to generate an output text sequence that is a shorter version of the input text sequence but that conveys the same semantic meaning.

As another example, one text rewriting task can be to generate an output text sequence that is a more elaborate version of the input text sequence but that conveys the same semantic meaning.

As another example, one text rewriting task can be to generate an output text sequence that a paraphrased version of the input text sequence, i.e., one that uses different words from the input text sequence but that conveys the same semantic meaning.

As another example, one text rewriting task can be to generate an output text sequence that is a proofread version of the input text sequence, i.e., one that corrects grammar and spelling mistakes in the input text sequence.

As another example, the text processing task can be a task that requires generating an output text sequence that is a completion of an input text sequence.

As another example, the text processing tasks can include a task that requires generating an output text sequence that is an answer to or a response to a query posed by the input text sequence. For example, the inference system can be deployed as part of a “chat bot” or dialog system that responds to queries posed by users.

As another example, the text processing task can be text classification tasks, e.g., tasks that require classifying an input sequence of text into one of multiple categories. Examples of such tasks include entailment tasks, textual similarity tasks, sentiment tasks, grammaticality tasks, and so on.

As another example, the task can be a computer code generation task, where the input is a sequence of text describing the functionality of a piece of computer code, or a sequence of computer code to be modified or completed, or both and the output is a sequence of computed code that modifies the computer code, that has the functionality that is described by the sequence of text, or both.

As another example, the task can be a computer code understanding task, where the input is a sequence of computer code, and the output characterizes the sequence of computer code, e.g., summarizes the function of the code, describes review comments on the code, and so on.

As yet another example, the task can be an image processing task, e.g., a task that requires processing an input sequence that includes one or more tokens representing an image, e.g., generated by processing the image using a pre-trained encoder neural network. Examples of such tasks include image captioning, e.g., where the input represents an image and the output is a natural language text caption for the image, visual question-answering, where the input includes a text question about an image and tokens representing the image and the output includes a natural language answer to the image, and so on.

In some cases, the task can be a multi-modal task that requires processing, generating, or both tokens of multiple different modalities, e.g., two or more of text, images, video, audio, or other sensor data.

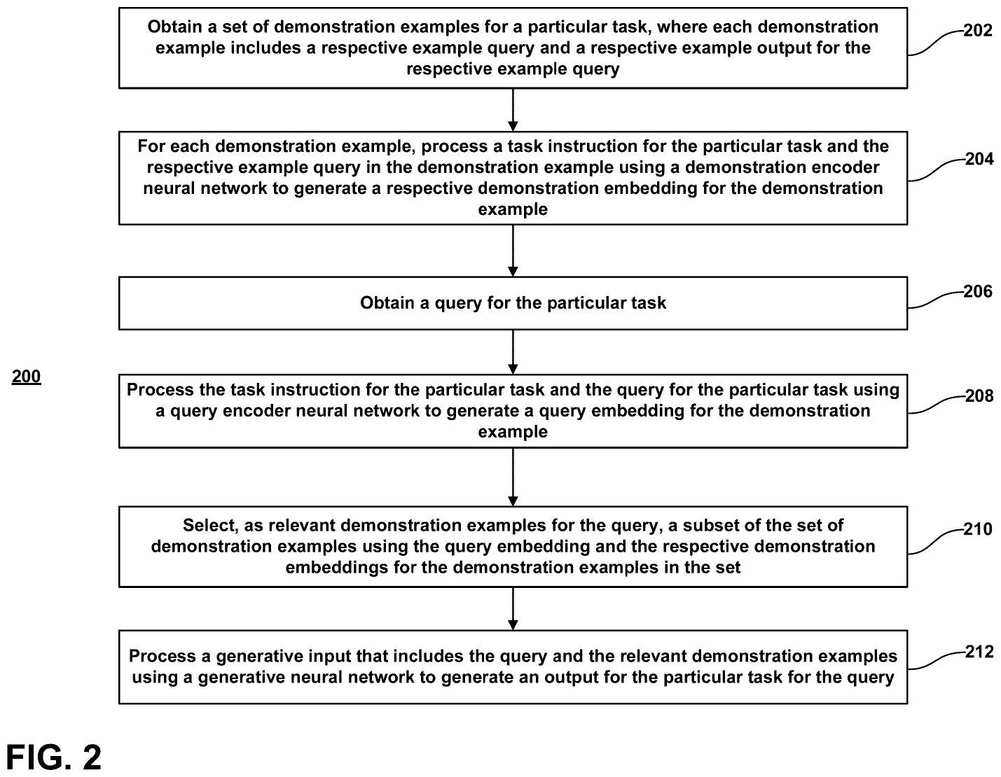

FIG. 2 is a flow diagram of an example process 200 for generating an output for a particular task and query. For convenience, the process 200 will be described as being performed by a system of one or more computers located in one or more locations. For example, a retrieval system, e.g., the retrieval system 100 of FIG. 1, appropriately programmed in accordance with this specification, can perform the process 200.

The system obtains a set of demonstration examples for a particular task, where each demonstration example includes a respective example query and a respective example output for the respective example query (step 202).

The system can obtain the set of demonstration examples from any of a variety of sources including a user, system memory, or another system, e.g., through a network connection, e.g., a cloud-based network, the internet, or a local network.

As described above, the task can be any of variety of types of tasks, such as a translation, a paraphrasing task, a natural language inference task, a reasoning task, a classification task, an extraction task, a tagging task, a generation task, a summarization task, and so on.

The system, for each demonstration example, processes a task instruction for the particular task and the respective example query in the demonstration example using a demonstration encoder neural network to generate a respective demonstration embedding for the demonstration example (step 204).

As described above, the demonstration encoder neural network can have any appropriate architecture in any appropriate configuration that can process the task instruction and the example query to generate the demonstration embedding, including fully connected layers, convolutional layers, recurrent layers, attention-based layers, and so on, as is appropriate.

For example, the demonstration encoder neural network can be a self-attention neural network that includes one or more self-attention layers.

In some implementations, as part of step 204, the system processes the task instruction for the particular task, the respective example query in the demonstration example and the respective example output in the demonstration example using the demonstration encoder neural network to generate the respective demonstration embedding for the demonstration example.

For example, for the DDI13 relation extraction task (i.e., a task of identifying the type of interaction between two drugs) with an instruction of “identify the interaction type between two drugs”, an example query of “Warfarin and Aspirin”, and an example output of “effect” (i.e., a classification of the drug interaction that signifies the drugs affect each other), the system can process the concatenation of these as “identify the interaction type between two drugs; Warfarin and Aspirin; effect” using the demonstration encoder neural network to generate the demonstration embedding.

In some other implementations, as part of step 204, the system processes the task instruction for the particular task and the respective example query in the demonstration example using the demonstration encoder neural network without processing the respective example output in the demonstration example.

For example, the system can process the task instruction for the particular task, the respective example query in the demonstration example, and a description of the respective example output in the demonstration example using the demonstration encoder neural network.

As a particular example, considering the above example DDI13 relation extraction task, instead of processing the example output “effect” (i.e., a classification label of the type of drug interaction) the system can process a description for “effect”, e.g., “The first drug causes a change or effect in the second drug”. So, for example, the system can process the concatenation of the instruction, example query, and description as “identify the interaction type between two drugs; Warfarin and Aspirin; The first drug causes a change or effect in the second drug” using the demonstration encoder neural network to generate the demonstration embedding.

Processing a description of the respective example output is different from processing the example output itself in that the description provides richer semantic context. The example output is often a short, symbolic label (e.g., “effect”) that lacks context, whereas the description can be natural language sentence(s) that explains the meaning of that label. So, by processing the sentence(s), the demonstration encoder can generate an embedding based on the conceptual meaning of the output, rather than just the surface-level string of the label itself.

In some implementations, as part of step 204, the system processes the task instruction for the particular task and the respective example query in the demonstration example without processing any data identifying the respective example output in the demonstration example.

For example, considering the above examples of the DDI13 relation extraction task, the system does not process the example output “effect” (i.e., a classification label of the type of drug interaction) or the example output description. So, for example, the system can process just the concatenation of the instruction, and example query as “identify the interaction type between two drugs; Warfarin and Aspirin” using the demonstration encoder neural network to generate the demonstration embedding.

These different techniques for generating demonstration embeddings described above provide different advantages. The technique that includes processing the example output directly can be effective when the output format is simple and consistent across tasks. The technique that includes processing a description of the example output can provide richer semantic context to the demonstration encoder neural network, which may be beneficial for tasks with abstract output labels. The technique that includes processing only the task instruction and example query, without any data identifying the example output, is particularly advantageous for improving the generalization of the demonstration embeddings for various tasks. That is, this approach prevents the demonstration encoder neural network from overfitting to the specific example output formats of the tasks seen during training. As a result, the demonstration embeddings can be used to identify semantically similar task inputs, which enables effective retrieval of demonstration examples for new, unseen tasks even when their output formats are substantially different from the training tasks.

Generally, the system can perform step 204 for all of the demonstration examples for a particular task and store the generated demonstration embeddings in an index, database, or other data repository. This is computationally efficient, as the stored embeddings can be re-used for many different queries for the particular task without needing to be re-generated each time.

The system obtains a query for the particular task (step 206).

The system can obtain the query from any of a variety of sources including a user, system memory, or another system, e.g., through a network connection, e.g., a cloud-based network, the internet, or a local network. For example, the system can receive the query from a user via network communication with a user device that the user is interacting with.

The system processes the task instruction for the particular task and the query for the particular task using a query encoder neural network to generate a query embedding for the demonstration example (step 208).

As described above, the query encoder neural network can have any appropriate architecture in any appropriate configuration that can process the task instruction and the query to generate the query embedding, including fully connected layers, convolutional layers, recurrent layers, attention-based layers, and so on, as is appropriate.

For example, the demonstration encoder neural network can be a self-attention neural network that includes one or more self-attention layers.

In some cases, the query encoder neural network and the demonstration encoder neural network are the same neural network. For example, both neural networks can share the same neural network architecture with the same trained neural network parameter values.

But in other cases, the query encoder neural network and the demonstration encoder neural network are different neural networks. For example, the neural networks can have different architectures, have different trained neural network parameters, are trained using different training data sets, or any combination of these.

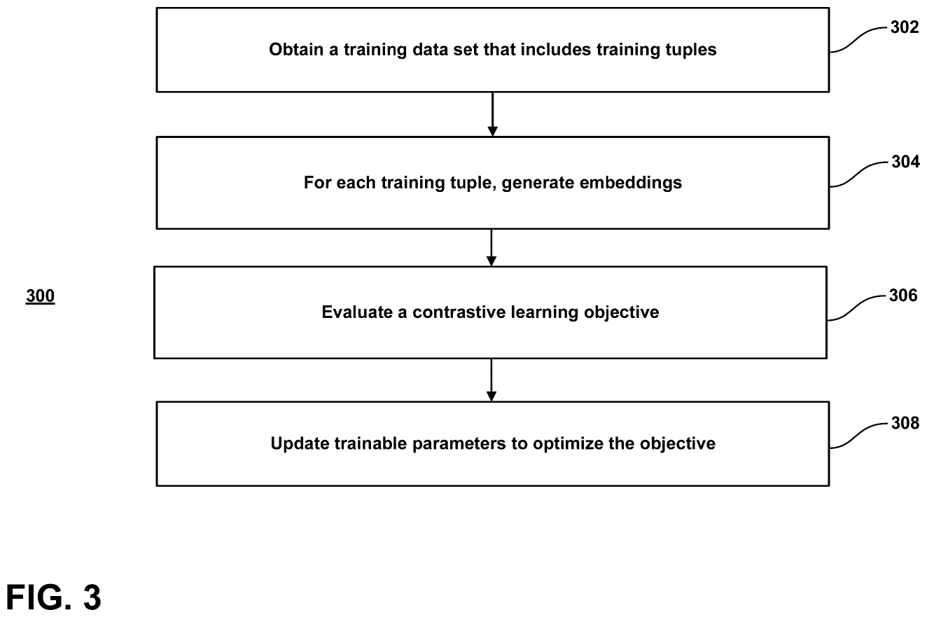

Prior to using the demonstration encoder neural network and query encoder neural network the system or another training system trains these neural networks. For example, the system can train the query encoder neural network and the demonstration encoder neural network using a contrastive learning objective and a respective set of training tuples for each of a plurality of different tasks. Further details of training the demonstration encoder neural network and query encoder neural network using a contrastive learning objective are described below in FIG. 3.

The system selects, as relevant demonstration examples for the query, a subset of the set of demonstration examples using the query embedding and the respective demonstration embeddings for the demonstration examples in the set (step 210).

As described above, the system can select the subset of demonstration examples based on a similarity measure (e.g., cosine similarity or Euclidean distance) between the query embedding and each respective demonstration embedding for the demonstration examples in the set.

For example, the system can determine k, where k is can be any positive integer, demonstration examples with the highest cosine similarity (i.e., cosine of the angle between the query embedding and the respective demonstration embedding) values to be included in the subset of demonstration examples.

The system processes a generative input that includes the query and the relevant demonstration examples using a generative neural network to generate an output for the particular task for the query (step 212).

The generative neural network can have any of a variety of neural network architectures. That is, the generative neural network can have any appropriate architecture in any appropriate configuration that can process an input sequence to generate an output sequence, including fully connected layers, convolutional layers, recurrent layers, attention-based layers, and so on, as is appropriate.

In some cases, the generative neural network is a pre-trained neural network (i.e., the system or another system has previously determined the values of the trainable parameters of the neural network through training on large data sets for one or more general tasks, e.g., next token prediction, image captioning, text-image alignment, and so on).

In some cases, the generative neural network processes a sequence of tokens to generate, as output, a sequence of tokens from a vocabulary, and the tokens can represent any modality of data such as text, image, audio, video and so on. For example, the generative neural network can be one that belongs to the Gemini family of neural networks, the Gemma family of neural networks, and so on.

In some implementations, the generative neural network is configured to process a sequence of tokens to auto-regressively generate an output sequence of tokens. That is, in some implementations, the generative neural network can be referred to as an auto-regressive neural network when the generative neural network auto-regressively generates an output sequence of tokens. More specifically, the auto-regressively generated output is created by generating each particular token in the output sequence conditioned on a current input sequence that includes any tokens that precede the particular token in the output sequence, e.g., the tokens that have already been generated for any previous positions in the output sequence that precede the particular position of the particular token.

For example, the generative neural network can be an auto-regressive Transformer-based neural network that includes (i) a plurality of attention blocks that each apply a self-attention operation and (ii) an output subnetwork that processes an output of the last attention block to generate the score distribution.

In this example, the generative neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rac, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Team, G., Mesnard, T., Hardin, C., Dadashi, R., Bhupatiraju, S., Pathak, S., Sifre, L., Rivière, M., Kale, M. S., Love, J. and Tafti, P., 2024. Gemma: Open models based on gemini research and technology. arXiv preprint arXiv: 2403.08295; and Team, G., Anil, R., Borgeaud, S., Alayrac, J. B., Yu, J., Soricut, R., Schalkwyk, J., Dai, A. M., Hauth, A., Millican, K. and Silver, D., 2023. Gemini: a family of highly capable multimodal models. arXiv preprint arXiv: 2312.11805.

Generally, to apply the self-attention operation, each attention block uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer.

Further in some cases, the generative neural network is a fine-tuned neural network (i.e., the system or another system updates previously determined pre-trained values of the trainable parameters of the generative neural network through further training on a task specific data set). During fine-tuning, the generative neural network's parameters (or a subset of them) are further adjusted, adapting the general knowledge acquired during pre-training to the specific nuances of processing an input sequence generate from a code input to generate an output sequence defining a natural language outline for the code input. This approach can improve the performance of generating natural language outlines while requiring less data and computational cost than training the generative neural network from scratch.

In some implementations, the generative neural network processes an input sequence that includes a prompt (e.g., zero-shot prompt, few-shot prompt, chain-of-thought prompt, and so on), which can remove the need for fine-tuning when the generative neural network is a pre-trained neural network.

Generally, the input sequence can represent any type of data (e.g., text, image, audio, video, or any combination of these). For example, the input sequence can be the result of the system tokenizing text, image, audio, video, or any combination of these.

As a particular example, for text, the system can use a text tokenizer to partition the text into a sequence of word or sub-word tokens. For example, the system can apply the Byte-Pair Encoding (BPE), WordPiece, or SentencePiece tokenizers to divide the natural language text data into tokens from a vocabulary.

As another particular example, for images, the system can partition the image into a grid of fixed-size patches, e.g., 16×16 pixel patches. Each patch is then treated as a single token and ordered into a sequence, for example, according to a raster scan order.

As another particular example, for audio, the system can first convert a raw audio waveform into a time-frequency representation, e.g., a spectrogram. The system can then partition the spectrogram into a sequence of frames, where each frame is treated as a token.

As another particular example, for video, the system can sample frames from the video at a particular rate. Each sampled frame can then be processed as a token. For instance, the system can partition each sampled frame into a grid of patches, with the final input sequence being a flattened sequence of all patches from all sampled frames, ordered temporally.

Thus, the system generates the generative input as an input sequence resulting from the tokenization of the query and the relevant demonstration examples so that they can be processed by the generative neural network.

In some implementations, the generative input further includes a task instruction for the particular task that is distinct from the task instruction processed by the demonstration encoder neural network and query encoder neural network.

For example, the task instruction included in the generative input can be longer than the task instruction processed by the demonstration and query encoders. As a particular example, if the task instruction that the demonstration and query encoders process is “Translation: English to Spanish” the task instruction included in the generative input can be “The goal of this task is to translate from English to Spanish.”

As an example generative input, the system can generate the following input sequence of tokens:
“The goal of this task is to translate from English to Spanish.
Input: Hello world
Output: Hola mundo
Input: How are you?
Output: [symbol] Cómo estás?
Input: Good morning
Output: Buenos días
Input: Where is the Library?
Output:”
where the task instruction is “The goal of this task is to translate from English to Spanish”, the query is “Where is the Library?”, and the demonstrations are the three pairs of “inputs” and “outputs” that represent three demonstrations.

As described above, the output can be a sequence of output tokens, and this sequence of output tokens can represent data of any modality (e.g., text, image, audio, video, or any combination of these) and any type. The output tokens could represent, e.g., text in a natural or computer language, a set of scores for a classification task, or data defining an action to be performed by an agent.

As an example output for a generative input, for the above example generative input, the output is ““ [symbol] Dónde está la biblioteca?”

In some implementations, the system outputs the output in response to the query. That is, in response to receiving the query, the system generates and outputs the output for the query.

For example, the system can receive the query from a user, then generate and output the output for presentation to the user on a user device (e.g., a smartphone, a laptop, a tablet, a smartwatch, and so on). As a particular example the system can receive the query as a typed user input on a laptop by a user over the internet. Then, in response to receiving the query from the user, the system can generate the output, send the output back to the laptop over the internet, and output the output as a displayed output on the laptop display to the user.

In some cases, the system uses the output to control the operation of other computer systems or physical devices. For example, the output could be a command that is transmitted over a network to control a robotic arm or adjust the settings of a smart home appliance. In other implementations, the output could be an API call that is sent to another software service to perform an action, such as booking a reservation or querying a database. The output could also be a sequence of computer code, e.g., a Python script, that is then executed by the system to perform a task.

FIG. 3 is a flow diagram of an example process 300 training a demonstration encoder neural network and a query encoder neural network using a contrastive learning objective. For convenience, the process 300 will be described as being performed by a system of one or more computers located in one or more locations. For example, a retrieval system, e.g., the retrieval system 100 of FIG. 1, appropriately programmed in accordance with this specification, can perform the process 300.

As described above, in some cases, the demonstration encoder neural network and the query encoder neural network are the same neural network. But, in other cases, they are different neural networks. In either case, the system repeatedly updates the trainable parameters of the demonstration encoder neural network and the query encoder neural network using a training data set. That is, the system can repeatedly perform the following described example process 300 using training tuples to repeatedly update all or a subset of the trainable parameters of the demonstration encoder neural network and the query encoder neural network from previously undetermined values, e.g., randomly initialized values, or from previously determined values, e.g., pre-trained values.

The system obtains a training data set that includes training tuples (step 302).

Generally, the training data set includes a respective set of training tuples for each of a plurality of different tasks.

The tasks can be any of a variety of types of tasks, e.g., machine translation, sentiment classification, named entity recognition, code summarization, and so on. Additionally, in some cases, the different tasks include tasks in different natural languages. That is, the tasks can be “multi-lingual tasks” where the tasks operate in multiple languages (e.g., a machine translation task between English and Spanish) the tasks can be a collection different single-language tasks (e.g., a set including an English-only sentiment task and a separate task for sentiment in Amharic and Hausa), or both.

Generally, for each of the different tasks, each training tuple includes: (i) a training query for the task, (ii) a positive demonstration example for the query, and (iii) a set of one or more negative demonstration examples for the query.

Generally, the positive demonstration example is a demonstration example that is helpful to the generative neural network to generate a correct output. While, generally, each of the one or more negative demonstration examples is a demonstration example that is not helpful to the generative neural network to generate a correct output.

In some implementations, that system uses a generative neural network to select positive and negative demonstration examples for the task. That is, the system can select the positive and negative demonstration examples based on (i) a performance of the generative neural network on the task given that the positive demonstration example is included in an input for the generative neural network along with the training query relative to (ii) a performance of the generative neural network on the task given that the negative demonstration example is included in an input for the generative neural network along with the training query. By using a generative neural network to select positive and negative demonstration examples for the task the system effectively evaluates demonstration examples to determine if they help or hinder the generative network's ability to generate a correct output for the training query.

The generative neural network can have any appropriate architecture in any appropriate configuration that can process an input sequence to generate an output sequence, including fully connected layers, convolutional layers, recurrent layers, attention-based layers, and so on, as is appropriate, as described above. But the generative neural network used during this training process is not necessarily the same one that generates the output for query during inference. For example, the system can use Flan-PaLM 2 during the training process, while the system uses Gemini 1.5 Pro to generate the output.

As an example of the system selecting positive and negative demonstration examples for the task using the generative neural network, the system can score demonstration examples using the generative neural network and select positive and negative demonstration examples based on these scores.

In particular, for this example, the system can use the generative neural network to generate a score for each demonstration example for the task. For example, the system can use the incremental utility function u(x, y, t) generated using the generative neural network (as described in arXiv: 2311.09619), where u represents the score, d represents the demonstration example, x represents the query being processed, y represents a “gold output” (i.e., correct ground truth output for query x), and t represents the task. For the utility function, a score >0.5 means that the demonstration example d helps the generative neural network to generate a correct output, a score <0.5 means the demonstration example d hinders the generative network to generate a correct output, and a score=0.5 means the demonstration example d neither helps nor hinders the generative network to generate a correct output.

After scoring the demonstration examples for the task, the system can select positive and negative demonstration examples. For example, the system can determine a demonstration example that satisfies u(x, y, t)≥0.5+81 is a positive demonstration example, where δ₁∈(0.0,0.5] is a margin to ensure the quality of demonstration example dₚ and the subscript p of dₚ indicates a positive demonstration example. Likewise, the system can determine demonstration examples that satisfy u(x, y, t)−u(x, y, t)≥δ₂ are negative demonstration examples, where δ₂∈[0.0,1.0] is another margin to ensure the quality difference between the positive and negative demonstration examples and the subscript n of dₙ indicates a positive demonstration example.

In some cases, the positive and negative demonstration examples have each been selected from a set of candidate demonstrations for the task, and the training query for the task has been selected from a set of query demonstrations for the task. That is, the positive and negative demonstration examples and the training query come from different, pre-determined, non-overlapping subsets of the overall training data set. For example, for a training query for the task, the positive and negative demonstration examples can be selected from a random sample of candidate demonstrations for the task.

In some cases, for each training tuple, the positive and negative demonstration examples have been selected from a subset of the candidate demonstrations for the task that has been selected for the training query in the training tuple using outputs of a baseline dense retrieval model. For example, to make the selection of positive and negative demonstration examples more efficient, the system can first use a baseline dense retrieval model to create a “shortlist” of relevant demonstrations examples from the full set of candidate demonstration examples. The final positive and negative examples are then chosen only from this smaller shortlist.

As a particular example, if the full set of candidate demonstrations for a task contains 100,000 examples, the system can first use a baseline dense retrieval model to determine the 100 candidates most relevant to the training query. The system can then select the final positive and negative demonstration examples from this much smaller subset of 100 candidates, e.g., using the scoring method described above.

In some implementations the baseline dense retrieval model includes a baseline query encoder neural network and a baseline demonstration encoder neural network. Further in some implementations, the initial values for the trainable parameters of the query encoder neural network and the demonstration encoder neural network are those of the baseline query encoder neural network and the baseline demonstration encoder neural network respectively.

In some implementations, the baseline query encoder neural network and the baseline demonstration encoder neural network are pre-trained on a large, general-purpose text corpus using a task-agnostic training objective. This pre-training endows these encoders with a general understanding of language and semantics. So, when the initial values for the trainable parameters of the query encoder neural network and the demonstration encoder neural network are those of the baseline query encoder neural network and the baseline demonstration encoder neural network respectively, the subsequent training adapts the pre-training values to the specific nuances of the training.

In some cases, the system augments the tasks included in the training data by generating new multi-lingual tasks from pre-existing single-language tasks in the training data set. That is, the system, for each single-language pre-existing task of a subset of tasks in the training data set, translates the associated set of candidate demonstrations for the pre-existing task into one natural language and the associated set of query demonstrations into another different natural language.

For example, the system for an English sentiment classification task, can translate English movie reviews (the candidate demonstrations) into Spanish and the English queries into German. The result is a new, synthetic, multi-lingual task that is distinct from the original pre-existing task. The system can perform this translation using a machine translation system, e.g., using a pre-trained machine translation model or a large-scale, pre-trained language model configured for translation tasks.

In some cases, when the system augments the tasks included in the training data by generating new multi-lingual tasks, the languages that the system translates the set of candidate demonstrations into and the language that the system translates the set of query demonstrations into are each sampled randomly from a set of possible natural languages. For example, for a given English query, the system might randomly select Japanese as the target language for translation, and for a candidate demonstration, it might randomly select Arabic.

The system, for each training tuple, generates embeddings (step 304). That is, for each training tuple, the system uses the query encoder to process the training query to generate a training query embedding, the demonstration encoder neural network to process the positive demonstration example to generate a positive demonstration embedding, and the demonstration encoder to process each negative demonstration example to generate a respective negative demonstration embedding. This embedding generation process is analogous to the one used during inference (as described in steps 204 and 208). Specifically, to generate the training query embedding, the query encoder processes the task instruction and the training query. To generate the positive and negative demonstration embeddings, the demonstration encoder processes the task instruction and the respective example query from each demonstration example, and this process can be performed in one of several ways consistent with the method used during inference, e.g., by also processing the respective example output, by processing a description of the example output in its stead, or by processing no data that identifies the example output.

The system evaluates a contrastive learning objective (step 306). For example, the system evaluates a contrastive learning objective designed to maximize the similarity between the query embedding and the positive demonstration embedding while simultaneously minimizing the similarity between the query embedding and each negative demonstration embedding.

For example, the contrastive learning objective can be formulated as a cross-entropy loss that attempts to correctly classify the positive demonstration example from the set of negative demonstration examples for a given training query. For example, The Additive Margin Softmax objective (as described in arXiv: 1902.08564) modifies the similarity score of the positive pair (training query, positive demonstration example) by subtracting a fixed margin before calculating the softmax probabilities. This makes the training task more difficult, forcing the demonstration encoder neural network and query encoder neural network to create a clearer separation in the embedding space between positive and negative demonstration examples.

Other examples of contrastive learning objectives include Triplet Loss, which aims to ensure the distance between the training query and a positive demonstration example is smaller than the distance between the training query and a negative demonstration example by a specified margin, and InfoNCE Loss, which also uses a softmax cross-entropy formulation to distinguish a single positive demonstration example from many negative demonstration examples.

The system updates trainable parameters to optimize the objective (step 308).

The system can update the trainable parameters of the demonstration encoder neural network and the query encoder neural network in any variety of ways, e.g., gradient based method, evolutionary algorithm-based method, Bayesian optimization, etc.

For example, the system can optimize the objective using any of a variety of gradient descent techniques (e.g., batch gradient descent, stochastic gradient descent, or mini-batch gradient descent) that include the use of a backpropagation technique to estimate the gradient of the loss with respect to trainable parameters of the demonstration encoder neural network and the query encoder neural network and to update the learnable parameters accordingly.

Generally, the system repeats the above steps until one or more criteria are satisfied (e.g., the system performs a pre-determined number of iterations, the updates to the trainable parameters no longer exceed a pre-determined magnitude of change, a metric regarding a validation dataset exceeds a pre-determined value, and so on).

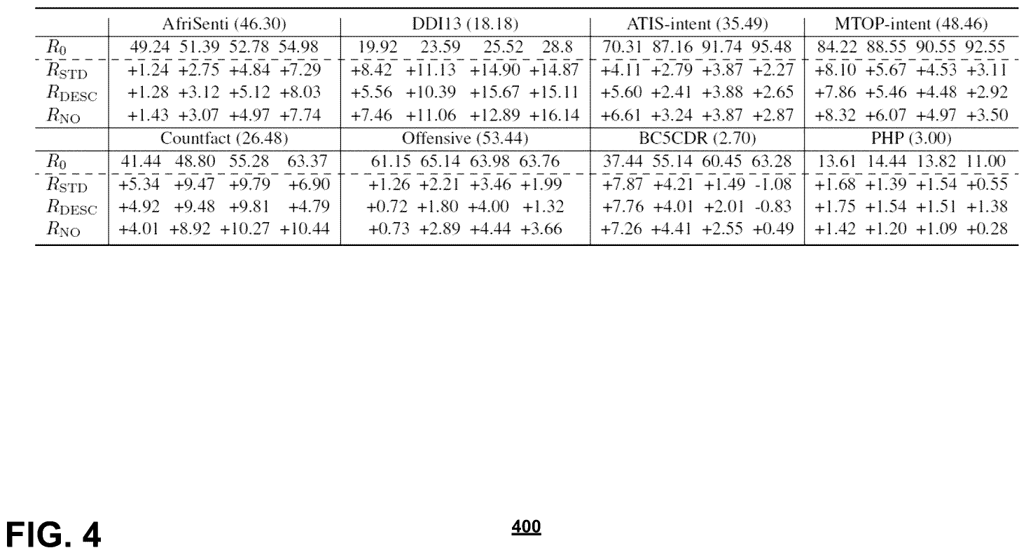

FIG. 4 is an example 400 of the performance of the described techniques.

In particular, example 400 is a table summarizing the performance of the described techniques on a selection of tasks used during training of the query encoder neural network and demonstration encoder neural network. These tasks, labeled as AfriSenti, DDI13, ATIS-intent, MTOP-intent, Countfact, Offensive, BC5CDR, and PHP, are evaluated using scores for that have a range of [0,100] that reflect the accuracy of the output to a query, where 100 is the best score and 0 is the worst. The table shows the performance score for processing a generative input that includes the query but no demonstration examples using the generative neural network as the parenthetical value next to the task name. Each column for each task corresponds to the generative input including 1, 3, 5, and 10 relevant demonstration examples respectively.

The row labeled R₀ corresponds to using a baseline query encoder neural network and demonstration encoder neural network (e.g., no fine-tuning of the encoders). The rows labeled R_{STD}, R_{DESC}, and R_{NO} correspond to the described techniques of fine-tuning an initial baseline query encoder neural network and demonstration encoder neural network, where the demonstration encoder neural network processes different inputs to generate demonstration example embeddings. In particular, the row labeled R_{STD} represents the described techniques when the demonstration encoder neural network processes the task instruction along with the demonstration example query and demonstration example output to generate the demonstration embedding. The row labeled R_{DESC} represents the described techniques when the demonstration encoder neural network processes the task instruction along with the demonstration example query and a description of the demonstration example output to generate the demonstration embedding. The row labeled R_{NO} represents the described techniques when the demonstration encoder neural network processes the task instruction along with just the demonstration example query.

Example 400 generally shows two key advantages of the described techniques. First that fine-tuning the query encoder neural network and demonstration encoder neural network from initial baseline encoders improve the accuracies of outputs to queries. As described above, these baseline encoders may be pre-trained on a large text corpus using a general-purpose, task-agnostic objective before being fine-tuned.

Secondly, example 400 shows that generating a demonstration embedding by not processing any data identifying the respective example output of the demonstration enables improved selection of relevant demonstration examples to be included in the generative input. This can be concluded from the improvement of the accuracies of outputs for queries in rows labeled R_{NO} over rows labeled R_{STD} and R_{DESC}. For example, the task Countfact illustrates a significant improvement of the row labeled R_{NO} over rows labeled R_{STD} and R_{DESC}.

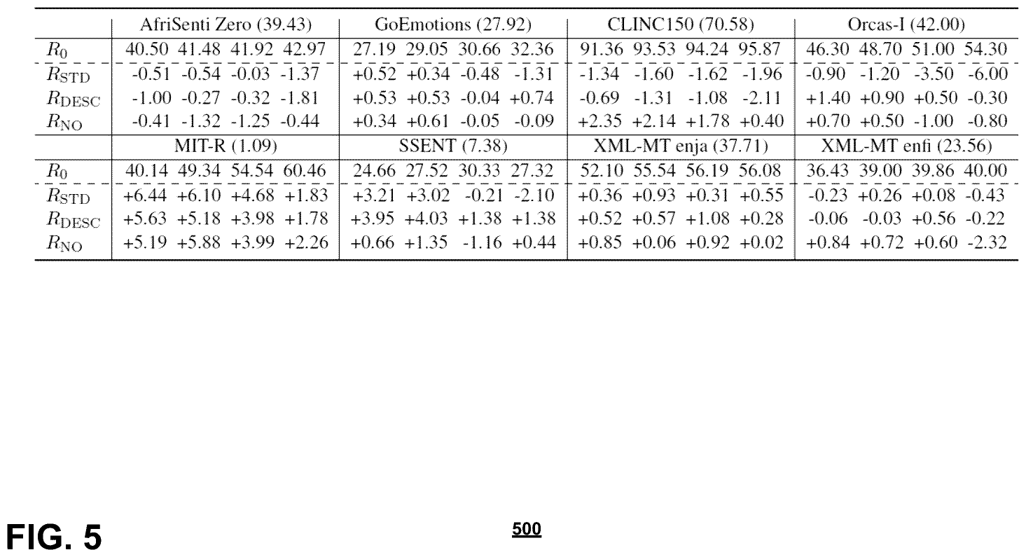

FIG. 5 is an example 500 of the performance of the described techniques.

In particular, example 500 is a table summarizing the performance of the described techniques on a selection of tasks not used during training of the query encoder neural network and demonstration encoder neural network. These unseen tasks serve to evaluate the generalization ability of the described techniques. The structure of example 500 is analogous to that of example 400 but with different tasks of course.

Example 500 demonstrates that generating a demonstration embedding without processing any data identifying the respective example output (i.e., the row labeled R_{NO}) is better for generalization than not. For example, for the task labeled CLINC150 R_{NO} noticeably outperforms R_{STD} and R_{DESC}.

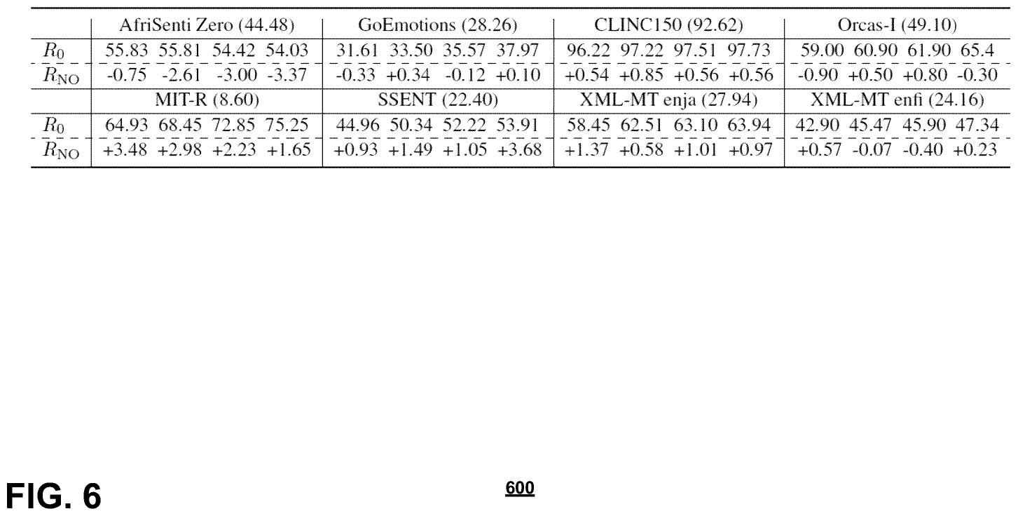

FIG. 6 is an example 600 of the performance of the described techniques.

In particular, example 600 is a table summarizing the performance of the described techniques on a selection of tasks not used during training of the query encoder neural network and demonstration encoder neural network, and using a generative neural network to generate outputs that is not the same as the generative neural network used for training the query encoder neural network and demonstration encoder neural network. Otherwise, the structure of example 600 is analogous to that of example 400.

Example 600 demonstrates that the described techniques improved performance continues when the generative neural network for inference (e.g., to generate outputs in response to user queries) is different from that used during training (e.g., to select candidate demonstrations as positive or negative demonstration examples).

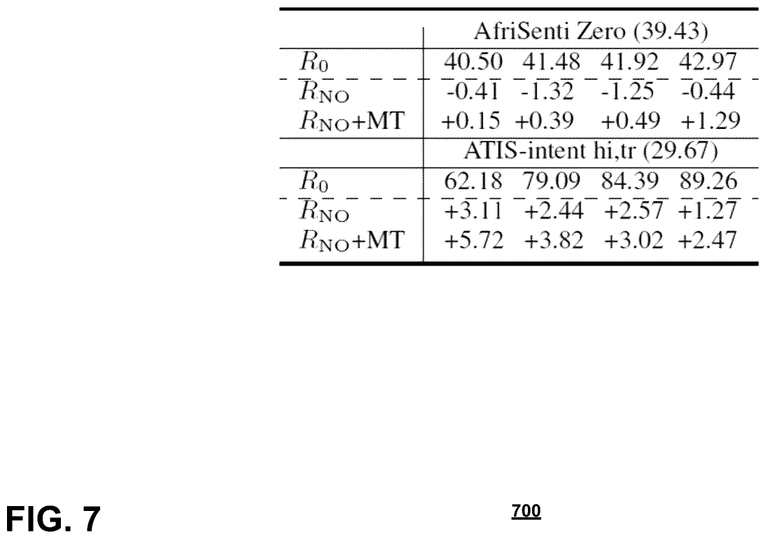

FIG. 7 is an example 700 of the performance of the described techniques.

In particular, example 700 is a table summarizing the performance of the described techniques on cross-lingual tasks. A cross-lingual task is one in which the natural language of the query is different from the natural language of the demonstration examples. The example 700 shows results for two cross-lingual tasks, “AfriSenti Zero” and “ATIS-intent hi, tr.” The structure of the table is analogous to that of example 400, but it compares the baseline query encoder neural network and demonstration encoder neural network (R₀), the fine-tuned encoders (R_{NO}), and fine-tuned encoders (R_{NO}+MT) that were trained with additional data generated by translating tasks, as described above.

Example 700 shows that augmenting the training data set by generating new multi-lingual tasks from pre-existing tasks confers the advantage of improved performance in cross-lingual scenarios. Example 700 illustrates that while standard fine-tuning (R_{NO}) can sometimes degrade performance on unseen languages compared to the baseline, the system trained with the augmented data (R_{NO}+MT) overcomes this issue and provides the best performance on the cross-lingual tasks shown.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining a set of demonstration examples for a particular task, the set of demonstration examples each comprising a respective example query and a respective example output for the respective example query;
for each demonstration example, processing a task instruction for the particular task and the respective example query in the demonstration example using a first encoder neural network to generate a respective demonstration embedding for the demonstration example;
obtaining a query for the particular task;
processing the task instruction for the particular task and the query for the particular task using a second encoder neural network to generate a query embedding for the demonstration example;
selecting, as relevant demonstration examples for the query, a subset of the set of demonstration examples using the query embedding and the respective demonstration embeddings for the demonstration examples in the set; and
processing a generative input comprising the query and the relevant demonstration examples using a generative neural network to generate an output for the particular task for the query.

2. The method of claim 1, further comprising:
outputting the output in response to the query.

3. The method of claim 2, wherein the query is received from a user and wherein outputting the output comprises providing the output for presentation to the user on a user device.

4. The method of claim 1, wherein the generative input further comprises a second task instruction for the particular task.

5. The method of claim 4, wherein the second task instruction is longer than the task instruction.

6. The method of claim 1, wherein processing a task instruction for the particular task and the respective example query in the demonstration example using a first encoder neural network to generate a respective demonstration embedding for the demonstration example comprises:
processing the task instruction for the particular task and the respective example query in the demonstration example without processing the respective example output in the demonstration example.

7. The method of claim 6, wherein processing the task instruction for the particular task and the respective example query in the demonstration example without processing the respective example output in the demonstration example comprises:
processing the task instruction for the particular task, the respective example query in the demonstration example, and a description of the respective example output in the demonstration example.

8. The method of claim 6, wherein processing a task instruction for the particular task and the respective example query in the demonstration example using a first encoder neural network to generate a respective demonstration embedding for the demonstration example comprises:
processing the task instruction for the particular task and the respective example query in the demonstration example without processing any data identifying the respective example output in the demonstration example.

9. The method of claim 1, wherein the second encoder neural network and the first encoder neural network have been trained through contrastive learning on a respective set of training tuples for each of a plurality of different tasks.

10. The method of claim 9, wherein, for each of the different tasks, each training tuple includes:
(i) a training query for the task,
(ii) a positive demonstration example for the query, and
(iii) a set of one or more negative demonstration examples for the query.

11. The method of claim 10, wherein the positive and negative demonstration examples have been selected based on (i) a performance of a first generative neural network on the task given that the positive demonstration example is included in an input for the first generative neural network along with the training query relative to (ii) a performance of the first generative neural network on the task given that the negative demonstration example is included in an input for the first generative neural network along with the training query.

12. The method of claim 10, wherein the positive and negative demonstration examples have each been selected from a set of candidate demonstrations for the task and wherein the training query for the task has been selected from a set of query demonstrations for the task.

13. The method of claim 12, wherein the different tasks include tasks in different natural languages.

14. The method of claim 13, wherein the set of candidate demonstrations and the set of query demonstrations for each task in a first subset of the plurality of different tasks have been generated by translating the set of candidate demonstrations for a second task in the plurality of different tasks into a first corresponding natural language and translating the set of query demonstrations for the second task into a second corresponding natural language.

15. The method of claim 14, wherein the first and second corresponding natural languages are sampled randomly from a set of possible natural languages.

16. The method of claim 12, wherein, for each training tuple, the positive and negative demonstration examples have been selected from a subset of the candidate demonstrations for the task that has been selected for the training query in the training tuple using outputs of a baseline dense retrieval model.

17. The method of claim 16, wherein the baseline dense retrieval model comprises a baseline second encoder neural network and a baseline first encoder neural network.

18. The method of claim 17, wherein the second encoder neural network and the first encoder neural network have been trained through contrastive learning on a respective set of training tuples for each of a plurality of different tasks; and wherein the second encoder neural network and the first encoder neural network have been trained through contrastive learning starting from parameter values of the baseline second encoder neural network and the baseline first encoder neural network.

19. The method of claim 1, wherein the second encoder neural network and the first encoder neural network are the same neural network.

20. The method of claim 1, wherein the second encoder neural network and the first encoder neural network are different neural networks.

21. The method of claim 1, wherein the second encoder neural network and the first encoder neural network are attention neural networks that include one or more self-attention layers.

22. A system comprising one or more computers and one or more storage devices storing instructions that when executed by the one or more computers cause the one more computers to perform operations, the operations comprising:
obtaining a set of demonstration examples for a particular task, the set of demonstration examples each comprising a respective example query and a respective example output for the respective example query;
for each demonstration example, processing a task instruction for the particular task and the respective example query in the demonstration example using a first encoder neural network to generate a respective demonstration embedding for the demonstration example;
obtaining a query for the particular task;
processing the task instruction for the particular task and the query for the particular task using a second encoder neural network to generate a query embedding for the demonstration example;
selecting, as relevant demonstration examples for the query, a subset of the set of demonstration examples using the query embedding and the respective demonstration embeddings for the demonstration examples in the set; and
processing a generative input comprising the query and the relevant demonstration examples using a generative neural network to generate an output for the particular task for the query.

23. One or more computer storage media storing instructions that when executed by one or more computers cause the one more computers to perform operations, the operations comprising:
obtaining a set of demonstration examples for a particular task, the set of demonstration examples each comprising a respective example query and a respective example output for the respective example query;
for each demonstration example, processing a task instruction for the particular task and the respective example query in the demonstration example using a first encoder neural network to generate a respective demonstration embedding for the demonstration example;
obtaining a query for the particular task;
processing the task instruction for the particular task and the query for the particular task using a second encoder neural network to generate a query embedding for the demonstration example;
selecting, as relevant demonstration examples for the query, a subset of the set of demonstration examples using the query embedding and the respective demonstration embeddings for the demonstration examples in the set; and
processing a generative input comprising the query and the relevant demonstration examples using a generative neural network to generate an output for the particular task for the query.
